(19) United States
(12) Patent Application Publication
(10) Pub. No.: US 2006/0226265 A1
(43) Pub. Date: Oct. 12, 2006

(54) Dosing device

(76) Inventors: Frank Miller, Ilsfeld (DE); Hart Albrodt, Tamm (DE)

Correspondence Address: KENYON & KENYON LLP, ONE BROADWAY, NEW YORK, NY, 10004, US

(21) Appl. No.: 10/534,194

(22) PCT Filed: Sep. 16, 2003
(86) PCT No.: PCT/DE03/03071

§ 371 Date: Apr. 12, 2006

(30) Foreign Application Priority Data
Nov. 6, 2002 (DE) 102 51 697.9

(51) Int. Cl. F02M 51/00

(52) U.S. Cl. 239/585.1

(57) ABSTRACT

A dosing device is for liquid fuels, e.g., for input into a chemical reformer in order to recover hydrogen, or into a secondary combustion device in order to generate heat. The dosing device has at least one metering device for metering fuel into a metering conduit, and a nozzle body, adjoining the metering conduit, having at least one spray discharge opening that opens into a metering chamber. The dosing device furthermore has a nozzle body that has a downstream support element with a swirl insert, disposed on the spray-discharge side, in which the at least one spray discharge opening is disposed.

### FIELD OF THE INVENTION

The present invention relates to a dosing device.

### BACKGROUND INFORMATION

In fuel-cell-assisted transport systems, so-called chemical reformers are used to recover the necessary hydrogen from hydrocarbon-containing fuels such as, for example, gasoline, ethanol, or methanol. Catalytic burners and secondary combustion devices are used to generate heat, especially during the cold-start phase.

All the substances required by the reformer for execution of the reaction, for example, air, water, and fuel, are conveyed to the reaction region ideally in a gaseous or at least atomized state. But because water and the fuels, for example, methanol or gasoline, may be present in liquid form on board the transport system, they must first be prepared shortly before they arrive at the reaction region of the reformer. This necessitates, for example, a dosing device which is capable of making the corresponding quantities of fuel or other substances available in finely atomized fashion.

The temperature necessary for the chemical reaction in which, for example, the fuel is reformed into hydrogen (inter alia) is made available by a so-called catalytic burner or secondary combustion device. Catalytic burners are components that have surfaces coated with a catalyst. In these catalytic burners, the fuel/air mixture is converted into heat and exhaust gases, the resulting heat being conveyed, for example, via the enveloping surfaces and/or via the hot exhaust gas stream, to the corresponding components such as the chemical reformer or an evaporator.

The conversion of fuel into heat is highly dependent on the size of the fuel droplets that strike the catalytic layer. The smaller the droplet size and the more uniformly the catalytic layer is wetted with the fuel droplets, the more completely the fuel is turned into heat and the higher the efficiency. The fuel is thus also converted more quickly, and pollutant emissions are reduced. Excessively large fuel droplets cause deposition on the catalytic layer and therefore slow conversion. That results, for example, in poor efficiency, especially during the cold-start phase.

Since the hydrogen is usually consumed immediately, chemical reformers must be capable of instantaneously adapting the production of hydrogen to demand, e.g., in the context of load changes or startup phases. Additional measures must be taken in the cold-start phase in particular, since the reformer is not supplying any waste heat. Conventional evaporators are not capable of instantaneously generating the corresponding quantities of gaseous reactants.

It is therefore useful to distribute the fuel with good preparation by a dosing device in finely distributed form and/or with good placement onto locations and surfaces on which the fuels can properly evaporate, for example into the reaction chamber or the premixing chamber of a reformer or catalytic burner, the internal surfaces of a cylindrical combustion chamber, or the internal enveloping surfaces of a catalytic burner. It is additionally useful to be able to adapt the fuel cloud, in terms of its geometric shape, propagation speed, and swirl formation, to the combustion chamber and to the conditions prevailing therein.

Apparatuses for dosing fuels into reformers are described, for example, in U.S. Pat. No. 3,971,847. Here the fuel is fed in, by metering devices relatively remote from the reformer, through long metering conduits and a single nozzle into a temperature-controlled material stream. The fuel first strikes impact panels that are disposed after the outlet opening of the nozzle and are intended to cause turbulence in and distribution of the fuel, and then enters the reaction region of the reformer through a relatively long evaporation section that is necessary for the evaporation process. The long metering conduit allows the metering device to be insulated from thermal influences of the reformer.

A particular disadvantage of such apparatuses is that below the operating temperature of the reformer, for example, in a cold-start phase, atomization of the fuel may only be insufficiently achieved, and the dosing device may be of very complex and bulky design. Because of the resulting relatively small reaction surface between fuel and oxidizer, the chemical reaction or combustion may occur only slowly, and usually also incompletely. Efficiency may greatly decrease as a result, and pollutant emissions may rise disadvantageously. Incomplete combustion or an incomplete chemical reaction may result in the formation of aggressive chemical components that can damage the chemical reformer or secondary combustion device and to deposits that can impair functionality. The complex and bulky design in the nozzle region, where atomization takes place, may result in high manufacturing and operating costs especially as a consequence of more difficulty in assembly and greater error susceptibility.

In particular, the propagation speed, geometrical shape, and swirl formation of the fuel cloud generated by the nozzle and impact panels can be influenced only in very inadequate fashion.

### SUMMARY

In a dosing device according to an example embodiment of the present invention, atomization and distribution of the fuel or the fuel/gas mixture may be substantially improved. For example, the propagation speed, swirl formation, and geometrical shape of the fuel cloud or fuel/gas mixture cloud in the combustion chamber or dosing chamber may be determined. As a result, for example, the cold-start phase may be substantially shortened, and the efficiency of the secondary combustion device or chemical reformer may be greatly increased already during the cold-start phase. Pollutant emissions may be substantially reduced. A dosing device according to an example embodiment of the present invention may make it possible to manufacture the dosing device in very simple, reliable, and therefore economical fashion. In addition, standardized components produced on a series basis may be used.

In a dosing device according to an example embodiment of the present invention, the nozzle body has an upstream supply tube and a downstream support element, both being of tubular, e.g., cylindrically tubular shape and being connected to one another in hydraulically sealed fashion by welding or laser welding. As a result, both parts may be manufactured easily and thus economically, and may each be economically manufactured separately in accordance with the particular requirement.

The swirl insert may be joined in hydraulically sealed fashion to the support element, e.g., by pressing, welding, laser welding, etc. Particularly strong, reliable, and economical joins may thereby be produced.

The swirl insert may have at least one seat element having a spray discharge opening, and a swirl element. The parts of the swirl insert may thus be easily and economically adapted to different loads and conditions.

The swirl element may be arranged in disk form. As a result, it may be machined particularly easily. In addition, the swirl element may have a continuous opening through which swirl development and swirl formation may be influenced.

In the dosing device, the swirl element may be joined to the seat element by welding, laser welding, etc. Economical manufacturing steps and reliable and strong joins may thereby be achieved.

It may be possible to dispose an intermediate element between the swirl element and the seat element. The swirl element may thereby be spaced away from the seat element so as to influence the swirl properties.

The swirl element may be disposed with a spacing from the wall of the support element. As a result, fuel inflow into the swirl element may be accomplished without hindrance and may also occur from the side of the wall of the support element in order, e.g., to enhance swirl formation.

The opening of the swirl element may be at least partially closed off with an insert. The swirl properties may thus be further improved and adapted to particular conditions and requirements. The insert may also be connected to the swirl element by welding, laser welding, etc.

The opening may have a longitudinal opening axis that has a directional component arranged in the flow direction of the fuel or the fuel/gas mixture.

The swirl element may have at least one swirl conduit that has a directional component radial and tangential to the longitudinal opening axis.

The metering conduit and the metering device may be joined in hydraulically sealed and detachable fashion by an adapter, thus enhancing ease of assembly.

The adapter connecting the metering conduit and the metering device may have an air inlet, the air inlet being connected in the adapter to the metering conduit. As a result, mixture preparation may already be initiated in the metering conduit, the fuel and/or gas fed into the metering line being mixed with air. The result may be an overall improvement in the atomization and mixture preparation of fuel and/or the metered-in gas with air. In addition, undesired fuel or gas residues may be eliminated from the metering line as a result of the air delivery, by being blown out with, for example, air through the air inlet, for example, before a stop phase or idle phase. Uncontrolled discharge of fuel into the metering chamber or the environment may thus be prevented.

A fuel injection valve, such as the one used, e.g., for reciprocating-piston machines with internal combustion, may be utilized as the metering device. The use of such valves may provide several advantages. For example, they may permit particularly accurate open- or closed-loop control of fuel metering, in which context the metering may be controlled by several parameters, such as pulse duty factor, clock frequency, optionally stroke length, etc. The dependency on pump pressure may be much less pronounced than in the case of metering devices that control the volumetric flow of the fuel by the conduit cross section, and the dosing range may be much larger.

In addition, fuel injection valves may be economical, reliable components that have proven successful in many manners, may be conventional in terms of their behavior, and may be chemically stable with respect to the fuels used. This may be particularly true in so-called low-pressure fuel injection valves that may be used with advantage because of the thermal decoupling resulting from the metering conduit.

The metering conduit may have a number of reduced-wall-thickness points that decrease the thermal conductivity of the metering conduit and may also serve as heat sinks.

The multi-part construction of the dosing device may make possible economical manufacture and the use of standardized components.

Exemplary embodiments of the present invention are explained in more detail below with reference to the appended Figures.

### BRIEF DESCRIPTION OF THE DRAWINGS

FIG. 1 schematically illustrates a dosing device according to an exemplary embodiment of the present invention.

FIG. 2 schematically illustrates, in cross-section, the nozzle body of the dosing device.

FIG. 3 schematically illustrates a swirl element of the dosing device.

FIG. 4 schematically illustrates, in cross-section, the nozzle body of a dosing device.

FIG. 5 schematically illustrates, in cross-section, the nozzle body of a dosing device.

### DETAILED DESCRIPTION

Exemplary embodiments of the present invention are described below by example. The exemplary embodiments of the dosing device that are illustrated may be suitable, e.g., for preparing and dosing liquid fuels and air into a hollow cylinder of a chemical reformer or a secondary combustion device with a spray angle of less than 60°.

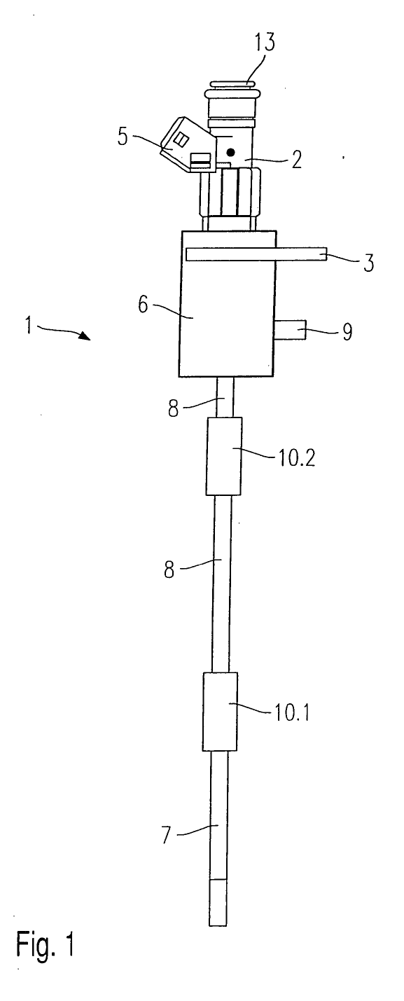

An exemplary embodiment of a dosing device 1 illustrated in FIG. 1 is arranged in the form of a dosing device 1 for the use of low-pressure fuel injection valves. Dosing device 1 is suitable, for example, for the input and atomization of fuel or a fuel/gas mixture into a metering chamber of a chemical reformer in order to recover hydrogen, or of a secondary combustion device in order to generate heat.

Dosing device 1 includes a metering device 2 which is arranged as a low-pressure fuel injection valve, an adapter 6 for receiving metering device 2 and a tubular metering conduit 8 that is, e.g., 10 to 100 cm long, an air inlet 9, and a nozzle body 7. Metering device 2 is tubular and has a fuel connector 13 on its upper side. At the side, metering device 2 has an electrical connector 5. Metering of fuel or a fuel/gas mixture into metering conduit 8 is accomplished on the lower side of metering device 2, adapter 6 connecting metering device 2 and metering conduit 8 to one another in an externally hydraulically sealed manner. Tubular air inlet 9 opens into adapter 6 and is thus in communication with metering conduit 8.

The hollow-cylindrical end of nozzle body 7 facing toward metering conduit 8 is connected in hydraulically sealed fashion to metering conduit 8 via a first connecting element 10.1 of hollow cylindrical shape. Metering conduit 8 itself includes, for example, a standardized metal tube made of stainless steel. Metering conduit 8 is arranged in two parts, the part of metering conduit 8 facing toward adapter 6 being connected by a second connecting element 10.2 to the part of metering conduit 8 facing toward nozzle body 7.

The lower part of metering device 2 engages into adapter 6 and is connected in hydraulically sealed fashion to adapter 6 by a mounting element 3 in the form of a clamp.

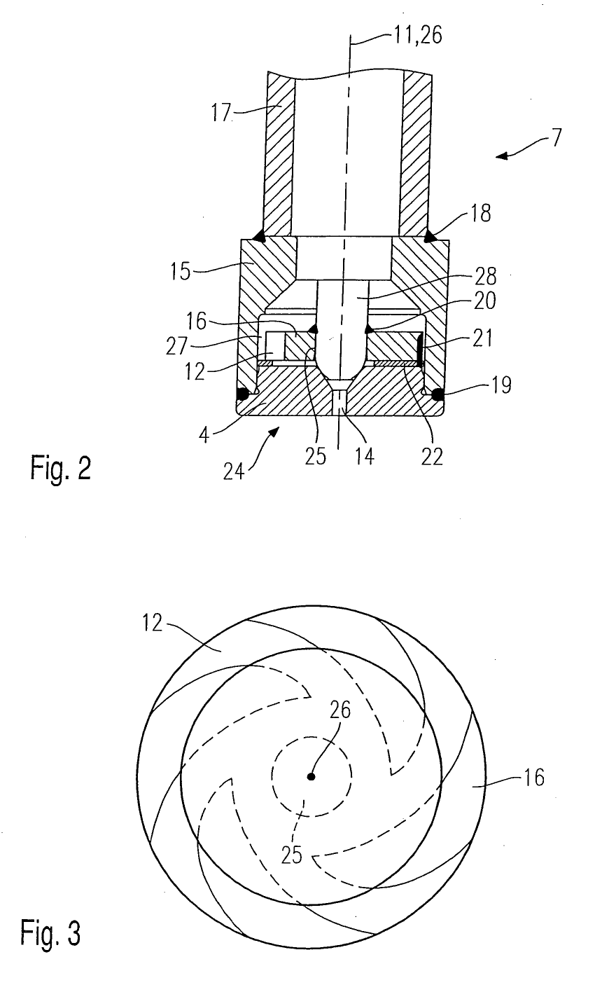

Nozzle body 7 has, in its spray-discharge end facing away from metering conduit 8, a swirl insert 24 that is illustrated in FIG. 2 and has at least one spray discharge opening 14.

Fuel, for example gasoline, ethanol, methanol, etc., is conveyed to metering device 2 under pressure from a fuel pump and fuel line through fuel connector 13 located on the upper side of metering device 2. When dosing device 1 is in operation, the fuel flows downwardly and is metered, through the sealing fit located in the lower end of metering device 2, into metering conduit 8 in conventional fashion by opening and closing the sealing fit. Air or other gases, for example, combustible residual gases from a reforming or fuel-cell process, may be conveyed, for mixture preparation, through air inlet 9 that opens through adapter 6 into metering conduit 8. As it continues, the fuel or fuel/gas mixture flows through metering conduit 8 to nozzle body 7 and is there metered in swirled fashion, through spray discharge opening 14 illustrated in FIG. 2, into the metering chamber.

Air may also be conveyed through air inlet 9 for controlled emptying of metering conduit 8, for example, shortly before an idle or stop phase.

As a result of metering conduit 8, metering device 2, e.g., the sealing fit of metering device 2 that is sensitive to high temperatures and large temperature fluctuations, is thermally decoupled from the temperatures in the metering chamber, which are, e.g., 500° C. The length, material, and shape of metering conduit 8 are selected, e.g., in accordance with thermal and physical conditions. Metering conduit 8 may also have reduced-wall-thickness points that may contribute to thermal insulation or act as heat sinks.

FIG. 2 schematically illustrates, in cross-section, nozzle body 7. Nozzle body 7 includes a support element 15, a supply tube 17, and swirl insert 24 disposed downstream in support element 15. All three aforesaid components 15, 17, 24 are cylindrical and are oriented concentrically on a longitudinal nozzle body axis 11 of nozzle body 7.

Supply tube 17, which is connected to metering conduit 8 (illustrated in FIG. 1) by first connecting element 10.1, is joined at its downstream end, in hydraulically sealed fashion, to support element 15 by a first weld seam 18 that is produced by laser welding. The join may also be implemented, however, by pressing, soldering, welding, a threaded connection, etc.

Swirl insert 24, located in the lower, downstream end of support element 15, includes a seat element 4 having spray discharge opening 14 disposed centeredly therein and a swirl element 16 having swirl conduits 12 and a centeredly disposed opening 25. Seat element 4 and swirl element 16 are each arranged in a disk shape. The downstream-facing disk underside of swirl element 16, and the upstream-facing upper disk side of seat element 4, rest against each other via an intermediate element 22 and are joined to one another with a fourth weld seam 21 that is produced by a laser welding method. Intermediate element 22 spaces seat element 4 and swirl element 16 apart. A distance 27 is present between the walls of support element 15 and the sides of swirl element 16 that face toward the wall of support element 15.

Longitudinal opening axis 26 of opening 25 is coincident with longitudinal nozzle body axis 11. Discharge opening 14 in seat element 4 is disposed concentrically with both axes 26, 11. A peg-shaped or cylindrical insert 28 engages through opening 25 of swirl element 16 and closes off opening 25. The downstream end of insert 28 does not, however, rest against seat element 4. As a result, the fuel or fuel/gas mixture may arrive at spray discharge opening 14, located downstream from swirl element 16, only through swirl conduits 12 disposed in swirl element 16. Insert 28 is mounted in hydraulically sealed fashion on swirl element 16, along its outer circumference against the upper disk side of swirl element 16, by a third weld seam 20.

Swirl insert 24 is mounted in hydraulically sealed fashion on seat element 4 on support element 15 by a second weld seam 19 that is produced using a laser welding method, second weld seam 19 extending approximately along the outer circumference of seat element 4.

FIG. 3 schematically illustrates a swirl element 16, from a point located upstream along longitudinal opening axis 26. The four swirl conduits 12 extend in the circular and disk-shaped swirl element 16 with a radial and tangential directional component with respect to longitudinal opening axis 26 of opening 25. The fuel or fuel/gas mixture enters swirl conduits 12 at the upstream upper disk side of swirl element 16 close to the outer circumference of swirl element 16 and at the sides of swirl element 16. The fuel or fuel/gas mixture is then directed, within swirl element 16, through swirl conduits 12 to the centeredly located opening 25, where the fuel emerges in swirled fashion on the lower disk side of swirl element 16 close to opening 25, and flows to spray discharge opening 14 illustrated in FIG. 2.

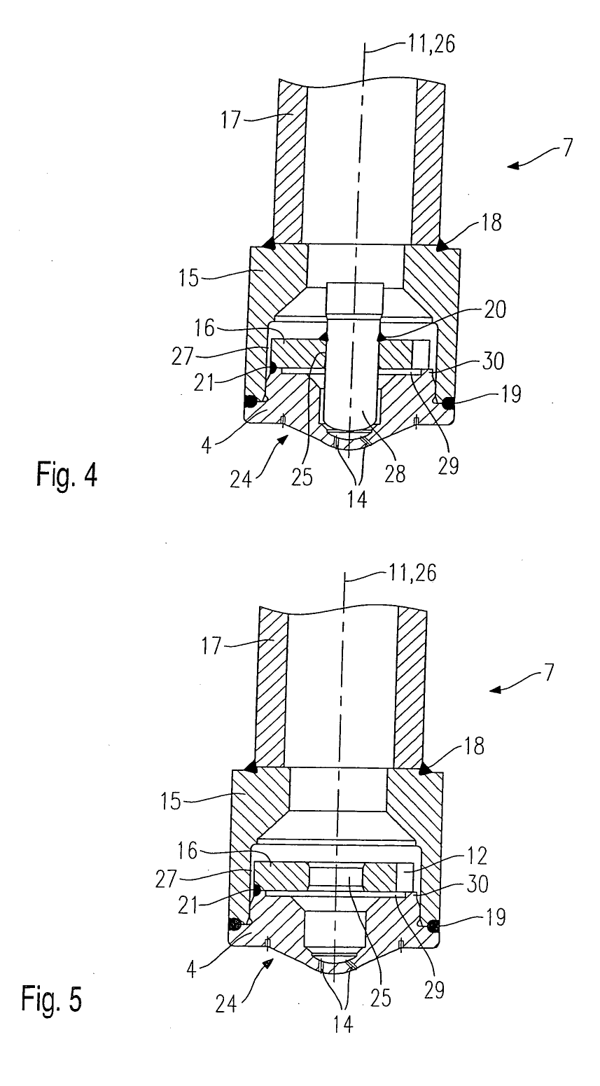

FIG. 4 is a schematic cross-sectional view of nozzle body 7 of an exemplary embodiment of dosing device 1, similar to that of the exemplary embodiment illustrated in FIG. 2. In contrast to the exemplary embodiment illustrated in FIG. 2, however, intermediate element 22 is substantially absent. In addition, seat element 4 belonging to swirl insert 24 has several spray discharge openings 14 having different inclination angles.

Intermediate element 22 used to space swirl element 16 and seat element 4 apart is replaced by a recess 29 disposed centeredly in the upstream upper disk side of seat element 4, swirl element 16 resting on ring 30 thereby created on the upper disk side of seat element 4.

FIG. 5 is a schematic cross-sectional view of nozzle body 7 of an exemplary embodiment of dosing device 1, this exemplary embodiment being very similar to that illustrated in FIG. 4. In contrast to the exemplary embodiment illustrated in FIG. 4, however, insert 28 is absent. The fuel or fuel/gas mixture may thus flow through opening 25 and swirl conduits 12 to spray discharge openings 14.

1-18. (canceled)

19. A dosing device for a liquid fuel, comprising:
at least one metering device adapted to meter fuel into a metering conduit;
a nozzle body adjoining the metering conduit, the nozzle body including at least one spray discharge opening that opens into a metering chamber, the nozzle body including a downstream support element having a swirl insert arranged on a spray-discharge side, the at least one spray discharge opening arranged in the swirl insert.

20. The dosing device according to claim 19, wherein the dosing device is adapted one of (a) to input the liquid fuel into a chemical reformer to recover hydrogen and (b) to input the liquid fuel into a secondary combustion device to generate heat.

21. The dosing device according to claim 19, wherein the support element is tubular, the nozzle body including, upstream from the support element, a tubular supply tube welded downstream in hydraulically sealed manner to the tubular support element.

22. The dosing device according to claim 21, wherein the tubular supply tube is arranged as a cylindrical tubular supply tube.

23. The dosing device according to claim 21, wherein the tubular supply tube is laser-welded downstream in hydraulically sealed manner to the tubular support element.

24. The dosing device according to claim 21, wherein the support element is cylindrically tubular.

25. The dosing device according to claim 19, wherein the swirl insert is joined in hydraulically sealed manner to the support element.

26. The dosing device according to claim 19, wherein the swirl insert is joined in hydraulically sealed manner to the support element by one of (a) pressing, (b) welding and (c) laser welding.

27. The dosing device according to claim 19, wherein the swirl insert includes at least one seat element having the at least one spray discharge opening and a swirl element arranged upstream from the seat element.

28. The dosing device according to claim 27, wherein the swirl element is disk-shaped.

29. The dosing device according to claim 27, wherein the swirl element includes a continuous opening.

30. The dosing device according to claim 29, wherein the opening is at least partially closed off by an insert.

31. The dosing device according to claim 30, wherein the insert is connected to the swirl element by one of (a) welding and (b) laser welding.

32. The dosing device according to claim 29, wherein the opening includes a longitudinal opening axis having a directional component pointing in a flow direction.

33. The dosing device according to claim 32, wherein the swirl element includes at least one swirl conduit having a directional component arranged radially and tangentially to the longitudinal opening axis.

34. The dosing device according to claim 27, wherein the swirl element is joined to the seat element by one of (a) welding and (b) laser welding.

35. The dosing device according to claim 27, further comprising an intermediate element arranged between the swirl element and the seat element.

36. The dosing device according to claim 27, wherein the swirl element is spaced from a wall of the support element by a distance.

37. The dosing device according to claim 19, further comprising an adapter joining in hydraulically sealed and detachable manner the metering conduit and the metering device.

38. The dosing device according to claim 37, wherein the adapter includes an air inlet connected in the adapter to the metering conduit.

39. The dosing device according to claim 19, wherein the metering device is arranged as a fuel injection valve.

40. The dosing device according to claim 39, wherein the fuel injection valve is arranged as a low-pressure fuel injection valve adapted to operate at a fuel pressure of up to 10 bar.

41. The dosing device according to claim 19, wherein the metering conduit includes, in an axial extent, one of (a) at least one reduced-wall-thickness point and (b) at least one reduced-wall-thickness region.
